(19) United States
(12) Patent Application Publication
(10) Pub. No.: US 2009/0189874 A1
(43) Pub. Date: Jul. 30, 2009

(54) IMAGE CAPTURE AND HAPTIC INPUT DEVICE

(75) Inventors: Denis Chene, Theys (FR); Charles Lenay, Compiegne (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/375,736

(22) PCT Filed: Jul. 31, 2007
(86) PCT No.: PCT/FR2007/051762

§ 371 Date: Jan. 30, 2009

(30) Foreign Application Priority Data
Aug. 3, 2006 (FR) 0653261

(51) Int. Cl. G06F 3/041

(52) U.S. Cl. 345/173

(57) ABSTRACT

The invention concerns an image capture and haptic input device. The device comprises at least one image sensor and haptic input means. The invention is characterized in that the image sensor is surrounded by the haptic input means. The latter can comprise discrete touch sensors distributed in a circle around the image sensor or in a matrix at the center of which the image sensor is positioned. The device can also comprise rows of touch sensors positioned offset from each other so that the touch sensors are staggered. In that case, the device comprises several image sensors positioned in interstices between the touch sensors. Instead of discrete touch sensors, the device can comprise a deformable sensitive membrane in the center of which an image sensor is positioned.

The invention relates to an image capture and haptic input device.

With the growth of telecommunications, a new method of communication is now emerging. This is haptic communication. The term “haptic” means that it relates to the sense of touch and movement, which concerns touch perception, proprioception and kynesthesia. A so-called “haptic” communication via a network consists in exchanging, for example, information that can be perceived by touch, in other words information involving a touch sensorial perception. As an illustrative example, take the case of a person transmitting to another remote person the outline of a shape, for example of a heart, in touch form. The outline of the heart is input by the person sending, by contact and movement of his index finger, or of a stylus, over a touch input surface, and, in reception, the other person perceives by touch, for example using the end of the fingers of one hand, the transmitted outline of the heart, on a touch rendering surface.

Such a method of communication can be combined with more conventional communication methods, such as video and/or audio. In particular, the US patent application 2005/0235032 describes an audio, video and haptic teleconferencing system comprising:
a video device comprising a display screen and an image capture camera,
an audio device comprising a microphone and a loudspeaker, and
a haptic device comprising:
a touch input deformable sensitive membrane for detecting by contact a movement and/or a force exerted, and generating a corresponding haptic signal, and
a second touch rendering deformable membrane adapted to be deformed and displaced, on receipt of a haptic signal.

Two remote people, each equipped with this teleconferencing system, can thus not only talk to each other and see each other, but can also touch each other, for example to shake hands.

Such a system requires the user to correctly position his camera in order to target the object or the phenomenon that he wants to capture and transmit the images to the other party, in particular in the case where he wants to have the latter touch what he is seeing.

The present invention is targeted at enabling a user to have what he is seeing touched in a more simple manner.

To this end, the invention relates to an image capture and haptic input device comprising image capture means and haptic input means, characterized in that the image capture means and the haptic input means are mounted on one and the same support surface and in that, the image capture means comprising at least one image sensor, the haptic input means surround said at least one image sensor, the whole being arranged so as to capture images of an object then input touch information concerning said object, by bringing the device and the object closer together.

The term “image sensor” should be understood to mean any device able to convert into a corresponding electrical signal the energy of an optical radiation emitted or reflected by an object or a phenomenon and which makes it possible to reconstruct images of this object or of this phenomenon. It may be a camera able to generate images from radiations in the visible band, an infrared sensor or an image sensor operating in any other spectral band.

Right away it will be noted that there are two types of haptic input means:
haptic input means requiring a physical contact with the object to input touch information;
haptic input means suitable for picking up touch information remotely, by using, for example, laser rays making it possible to pick up the shape of an object.

The inventive device can be used, initially, to capture images of an object by progressively bringing the device and the object closer together, so as to increasingly capture visual details of the object, then, secondly, provided that the object falls within the touch detection zone of the device, to input touch information relating to the object using the haptic input means surrounding the image sensor. Thanks to this device, the user can collect increasingly precise visual information and touch information relating to the object, by a simple motion consisting in progressively bringing his device and the object closer together then pressing his device against the object.

The arrangement of the haptic input means around the image sensor makes it possible to optimize the balance between what is input at touch level and what is captured at image level, in other words between the “touch” image and the visual image of the object, while ensuring a “visual-tactile continuity”. The expression “visual-tactile continuity” should be understood to mean the sequencing, without apparent interruption, in a continuous manner, of the visual image input and the touch input. This result is obtained when, during a zoom on an object, the latest clear image is captured substantially at the moment when the first touch information is input. For this, it is necessary for the area of visual clarity (corresponding to the area in which the object must be situated for the image sensor to input clear images) and the touch detection area (corresponding to the area in which the object must be situated for the touch input to be made) to overlap slightly or even have contiguous respective boundaries or at least boundaries close to one another. The start instant of the touch input can slightly precede or slightly follow the end instant of visual clarity (that is, the start of blurring) or even correspond exactly to that instant. In the case where the haptic input means are capable of picking up information before contact, the touch input begins before the end instant of visual clarity, in other words before the blurring. In the case where the haptic input means require contact, the touch input begins a little after the start of blurring. However, in both cases, the “loss of visual” boundary and the “making contact” boundary substantially correspond to each other.

The various individual touch images input by the different discrete touch sensors surrounding the image sensor make it possible to reconstruct an enveloping touch image of the visually input object, in which only the central part, less important when it comes to touch perception, is not input by touch because of the presence of the image sensor.

Advantageously, the haptic input means comprise a plurality of touch sensors distributed around said at least one image sensor. The touch sensors can be distributed uniformly around the image sensor. This makes it possible to make optimum use of the input means to input the maximum of touch information. Moreover, the use of discrete touch sensors makes it possible to simplify the construction of the device by simply mounting the image sensor and the touch sensors on one and the same support.

The touch sensors can be arranged in a circle around the lens. As a variant, the haptic input means can comprise a matrix of touch sensors, the image sensor then being able to be arranged at the center of said matrix.

In another embodiment, the device comprises a plurality of image sensors arranged in spaces separating the touch sensors.

The touch sensors can be arranged in parallel rows, each row comprising several sensors separated by interstices, and the image sensors can be arranged in said interstices. The adjacent rows of sensors are advantageously positioned offset relative to each other so as to obtain a staggered arrangement of the touch sensors.

The device thus makes it possible to obtain a detailed input of an object both at image level and at touch level, while ensuring a conformity, a balance between what is captured at image level and what is input at touch level.

In another embodiment, the haptic input means comprise a deformable sensitive membrane and the image sensor is positioned in a central area of said membrane.

The invention also relates to the use of the image capture and haptic input device defined previously for, initially, capturing images of an object by bringing the device and said object closer together, then, secondly, inputting touch information relating to the object when the device is in contact with it.

The invention finally relates to a terminal for communication via a network comprising an image capture and haptic input device as defined hereinabove. It can be, for example, a cell phone or any other communication element.

The invention will be better understood from the following description of various embodiments of the inventive visual and haptic input device, with reference to the appended drawings in which:

FIG. 1 represents a first embodiment of the visual and haptic input device;

FIG. 2 represents a second embodiment of the visual and haptic input device;

FIG. 3 represents a third embodiment of the visual and haptic input device;

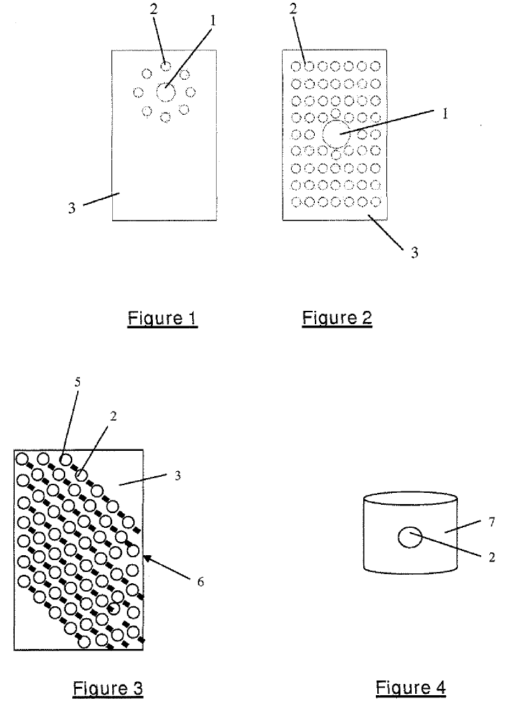

FIG. 4 represents a fourth embodiment of the visual and haptic input device;

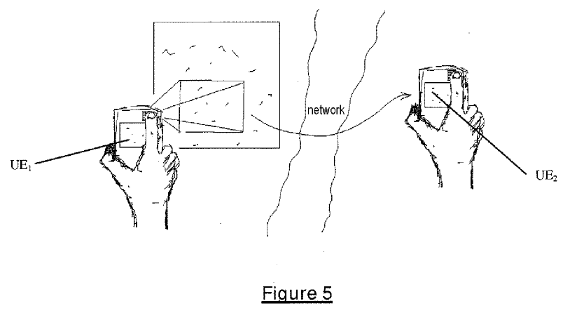

FIG. 5 diagrammatically represents a visual and haptic communication using the visual and haptic input device of one of FIGS. 1 to 4.

The inventive image capture and haptic input device comprises:
image capture means comprising at least one discrete image sensor and
haptic input means.

It will be recalled here that the term “image sensor” should be understood to mean a sensor capable of converting into a corresponding electrical signal, the energy of an optical radiation emitted or reflected by an object, a scene or a phenomenon and which makes it possible to reconstruct images of this object, of this scene or of this phenomenon. It can be an image sensor operating in the visible band, like an ordinary camera, in the infrared band or in any other spectral band. The electrical signal generated by the image sensor is then processed to be converted, in a manner that is well known, by processing means, into a digital type signal, that will be called “image signal”.

The haptic input means are adapted to detect the shape and/or the distribution of the pressure forces exerted by an element (object, finger, etc.), by contact, and to generate a corresponding electrical signal, which is then converted, in a known manner, by processing means, into a digital-type signal, that will be called “haptic signal”.

Straight away, it will be noted that the corresponding elements in the different figures are given the same references. FIGS. 1 to 4 illustrate different, nonlimiting, embodiments that are envisaged for the invention.

In FIGS. 1 to 3, the haptic input means comprise a plurality of discrete touch sensors 2. These sensors 2 make it possible to detect the presence of an object or to measure a force exerted, by contact.

In FIG. 1, the image capture means comprise a discrete image sensor, in this case a video camera 1, whose lens is represented in the figure, and the haptic input means comprise a plurality of discrete touch sensors 2. The lens of the camera 1 and the discrete touch sensors 2 are mounted on one and the same support 3. The touch sensors 2 are arranged in a circle around the lens 1 of the camera, close to the latter, and are distributed uniformly on this circle.

FIG. 2 represents a second embodiment of the inventive input device, which differs from the first described hereinabove by the fact that the haptic input means comprise a plurality of discrete touch sensors 2 arranged in a matrix. The lens 1 of the camera is positioned at the center of this matrix 4, in other words, at the intersection of the middle column of sensors 2 and of the horizontal middle row of sensors 2. The touch sensors 2 are thus distributed uniformly around the lens of the camera 1.

FIG. 3 shows a third embodiment of the inventive device in which the haptic input means comprise several parallel rows 6 of discrete touch sensors 2 and the image capture means comprise a plurality of discrete image sensors 5. In this case, they are infrared sensors. However, it would be possible to use image sensors operating in any other spectral band, for example in the visible band. In the particular example described here, the adjacent rows 6 are positioned offset relative to each other so that the touch sensors 2 are arranged overall in a “staggered” manner. The image sensors 5 are positioned in the interstices provided between the touch sensors 2 of each row 6. Thanks to the staggered arrangement of the touch sensors 2 and the positioning of the image sensors 5 in the interstices between the touch sensors 2 of the rows, each image sensor—except for those situated at the edge of the image capture and haptic input area—is surrounded by four touch sensors 5, distributed uniformly around the image sensor 5 concerned.

FIG. 4 shows a fourth embodiment of the image capture and haptic input device, in which the touch input means comprise a deformable sensitive surface for touch input 7, adapted to detect the shape and/or the distribution of the pressure forces exerted by an object in contact with it, and to generate a corresponding electrical signal, which is converted into a haptic signal by processing means. This type of membrane is well known to those skilled in the art and therefore will not be described in more detail here. The device also comprises an image capture camera 1, provided with a lens represented in FIG. 4 and positioned in the central part of the touch input sensitive surface.

As shown in FIGS. 1 to 4, the image capture means and the haptic input means are mounted on one and the same support surface in the different embodiments of the invention.

It will be stressed that the arrangement of the haptic input means around a given image sensor makes it possible to optimize the balance between what is captured at image level and what is input at touch level. Furthermore, a uniform distribution of the touch input means around the image sensor allows for an optimum use of the input means to input the maximum of touch information. As explained previously, the device thus ensures a visual-tactile continuity. In other words, the input of visual images and the touch input are sequenced without apparent interruption, continuously. This result is obtained when, during a zoom on an object, the latest clear image is captured substantially at the moment when the first touch information is input. For this, the area of visual clarity (corresponding to the area in which the object should be situated for the image sensor to input clear images) and the touch detection area (corresponding to the area in which the object must be situated for the touch input to be able to be made) overlap slightly or else have respective contiguous boundaries or at least boundaries close to one another. The start instant of touch input can slightly precede or slightly follow the end instant of visual clarity (that is, the start of blurring) or even correspond exactly to this instant. In the case where the haptic input means are capable of picking up information before contact, the touch input begins before the end instant of visual clarity, in other words before the blurring. In the case where the haptic input means require contact, the touch input begins a little after the start of blurring. However, in both cases, the “loss of visual” boundary and the “contact” boundary substantially correspond to each other.

The embodiments of FIGS. 1 to 4 are given as illustrative examples. The scope of the invention is not limited to these particular examples but extends to any image capture and haptic input device in which the haptic input means surround the image sensor or sensors.

Referring to FIG. 5, the invention also relates to the use of the image capture and haptic input device described previously for, initially, capturing images of an object by bringing the device and the object closer together, in order to display more and more details of the object, then, secondly, for inputting touch information relating to the object. In other words, the haptic input means and the image capture means are arranged so as to capture images of an object then to input touch information concerning said object, by bringing the device and the object closer together.

In the case where the haptic input means require physical contact, the input of the touch information is performed by a contact between the device and the object, which follows bringing the latter closer together. In the case where the haptic input means are capable of picking up touch information remotely, by using, for example laser rays making it possible to pick up the shape of an object, the input of the touch information does not require the operation of bringing the device and the object closer together to be followed by a contact.

The inventive image capture and haptic input device can be integrated in a network communication terminal, for example a cell phone. A user provided with such a cell phone UE₁ can thus, for example, when shopping, show another remote person, provided with a communication element integrating a display screen and a touch rendering surface, a wallpaper, in more and more detail, then have him touch the relief of the wallpaper, by progressively bringing the cell phone and the wallpaper closer together then by contact between the cell phone device and the wallpaper. The image input and touch input are performed one after the other, without interruption, in other words continuously.

1. An image capture and haptic input device comprising image capture means and haptic input means, characterized in that the image capture means and the haptic input means are mounted on one and the same support surface and in that, the image capture means comprising at least one image sensor, the haptic input means surround said at least one image sensor, the whole being arranged so as to capture images of an object then input touch information concerning said object, by bringing the device and the object closer together.

2. The device as claimed in claim 1, wherein the haptic input means comprise a plurality of discrete touch sensors distributed around at least one image sensor.

3. The device as claimed in claim 2, wherein the touch sensors are arranged in a circle around said image sensor.

4. The device as claimed in claim 2, wherein the haptic input means comprise a matrix of touch sensors and the image sensor is arranged at the center of said matrix.

5. The device as claimed in claim 2, wherein a plurality of image sensors is provided, arranged in spaces separating the touch sensors.

6. The device as claimed in claim 5, wherein the touch sensors are arranged in parallel rows, each row comprising several sensors separated by interstices, and the image sensors are arranged in said interstices.

7. The device as claimed in claim 6, wherein the adjacent rows of sensors are positioned offset relative to each other so as to obtain a staggered arrangement of the touch sensors.

8. The device as claimed in claim 1, wherein the haptic input means comprise a deformable sensitive membrane and the image sensor is positioned in a central area of said membrane.

9. The use of the image capture and haptic input device as claimed in one claim 1 for, initially, capturing images of an object, then, secondly, inputting touch information relating to the object by bringing the device and said object closer together.

10. A network communication terminal comprising an image capture and haptic input device as claimed in claim 1.
